(19) United States
(12) Patent Application Publication
(10) Pub. No.: US 2004/0206584 A1
(43) Pub. Date: Oct. 21, 2004

(54) Wear display device for displaying brake lining wear states

(76) Inventor: Peter Bihn, Wald-Michelbach (DE)

Correspondence Address: MOORE & VAN ALLEN, PLLC, 2200 W MAIN STREET, SUITE 800, DURHAM, NC, 27705, US

(21) Appl. No.: 10/811,540

(22) Filed: Mar. 29, 2004

(30) Foreign Application Priority Data
Mar. 28, 2003 (DK) 103 14 206.1

(51) Int. Cl. F16D 51/00

(52) U.S. Cl. 188/1.11 L

(57) ABSTRACT

An apparatus is provided for displaying the state of wear of a brake lining on a vehicle. The brake lining wear display apparatus comprises a wear sensor for sensing the state of wear of the brake lining and a display for providing a visual signal indicating the brake lining wear state. An electronic control/evaluation system controls the display device. An electrical connecting device connects the wear sensor to the electronic control/evaluation system. The electronic control/evaluation system evaluates signals from the wear sensor and provides a signal to the display for generating the visual signal. A memory storage device stores a current wear state of the brake lining as well as previously sensed wear states. A power supply device provides power to the wear display device.

### BACKGROUND

The present invention relates to a wear display device for displaying brake lining wear states.

In the construction of vehicles, the brake system of a vehicle is of particular importance. Conventional brake systems are subject to use-dependent wear so that the brake linings have to be replaced from time to time depending on wear. Nowadays, the brakes in a vehicle are typically equipped with a brake wear display. When a specific wear state is reached, a signal is displayed to the driver in the passenger compartment. After the brake lining or brake linings have been changed, the signal goes out again until a predetermined wear state re-occurs.

A known monitoring and display device for the wear of brake linings is described in DE 201 16 189. Here, a mechanical display element is used which is changed from its basic position into a warning position when wear is detected by means of an evaluation device using a sensor. The mechanical display element remains in this position even when an electrical signal is not applied. The disadvantage of this solution is, inter alia, the fact that only one wear signal is generated for the entire vehicle, that a wear signal is provided without a prewarning stage per wheel, and that, above all, there is no storage device provided for storing the brake lining wear states, even after the brake linings have been replaced.

### SUMMARY

The present invention is based on the object of providing a wear display device for displaying brake lining wear states which eliminates the abovementioned disadvantages.

This object is achieved according to the invention by means of an apparatus for displaying the state of wear of a brake lining on a vehicle. The brake lining wear display apparatus comprises a wear sensor for sensing the state of wear of the brake lining and a display for providing a visual signal indicating the brake lining wear state. An electronic control/evaluation system controls the display device. An electrical connecting device connects the wear sensor to the electronic control/evaluation system. The electronic control/evaluation system evaluates signals from the wear sensor and provides a signal to the display for generating the visual signal. A memory storage device stores a current wear state of the brake lining as well as previously sensed wear states. A power supply device provides power to the wear display device.

This object is also achieved according to the invention by means of a vehicle comprising a brakable axle including wheels, a brake lining operatively associated with at least one of the wheels, and an apparatus for displaying the state of wear of the at least one brake lining. The brake lining wear display apparatus comprises a wear sensor for sensing the state of wear of the at least one brake lining and a display for providing a visual signal indicating the brake lining wear state. An electronic control/evaluation system controls the display device. An electrical connecting device connects the wear sensor to the electronic control/evaluation system. The electronic control/evaluation system evaluates signals from the wear sensor and provides a signal to the display for generating the visual signal. A memory storage device stores a current wear state of the brake lining as well as previously sensed wear states. A power supply device provides power to the wear display device.

Further refinements of the invention are described below.

In the wear display device according to the invention it is advantageous in that, in addition to an independent power supply through an integrated battery, the device can also be fed via an external power supply. Furthermore, an additional prewarning stage may be provided for a brake lining, i.e. two signals are displayed per brake lining, specifically the final wear state as well as previously an intermediate wear stage. When the intermediate wear stage is reached and there is a corresponding display, the vehicle user is ensured a predetermined running capacity before the brake linings have to be replaced.

Moreover, the wear display device according to the invention permits connection for electronic brake systems (brake by wire) and also permits use in connection with drum brakes.

By means of a storage function of the system-integrated storage device which may only be read out by means of a password. Thus, it would be possible, for example, for a workshop to keep a record of whether the predefined wear limits of the brake lining or the already changed brake linings have been exceeded. In addition, there is the possibility of combining the brake lining wear state information with the odometer reading of the vehicle and storing it, and thus being able to follow precisely the service life of a brake lining.

According to a further embodiment of the present invention it is advantageously possible to detect and display a break in a cable comprising an electrical connecting device between the electronic control/evaluation device and a wear sensor.

Further advantages may be provided of being able to evaluate a signal of a wear sensor associated with each brakable wheel and if a parking brake is activated.

### BRIEF DESCRIPTION OF DRAWINGS

A preferred embodiment of the present invention will be described below with reference to a drawing for explaining further features. In said drawing:

FIG. 1 shows a schematic circuit diagram of a wear display device in order to explain an embodiment of the present invention.

### DESCRIPTION OF DRAWINGS

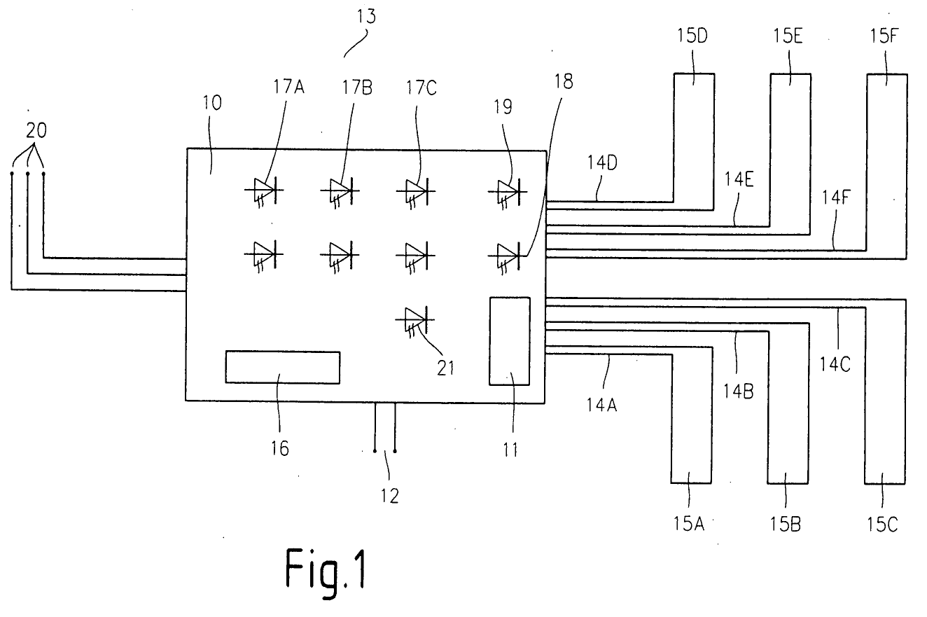

According to the present invention, the wear display device (illustrated by way of example in FIG. 1) for displaying brake lining wear states has a component mount 10, preferably a circuit board. This circuit board 10 has an integrated power supply device 11, in particular a battery, with the voltage 9 V for example. Furthermore, the circuit board 10 has an external power supply terminal 12 for providing power from an external source, for example in the range between about 5 V and about 60 V. A control/evaluation device 13, which is not illustrated in more detail in the drawing, on the circuit board 10 is supplied by means of either voltage supply device 11, 12. Electrical connecting devices 14A-F have the purpose of electrically connecting wear sensor devices 15A-F which are provided on each brake device of the vehicle (not illustrated). The wear sensor devices may be any suitable brake lining sensor, including sensors which are based on a disconnection of the circuit as well as on magnetic, optical, capacitive features or on ultrasonic features, and the like.

A memory storage device 16 is connected to the control/evaluation device 13. At the circuit board 10 end, the electrical connecting devices 14A, 14B, 14C, 14D, 14E, 14F are connected in the same way as a storage device 16, to the control/evaluation device 13. A predetermined wear state may be stored in the storage device 16 on the circuit board 10. Both wear states of the currently mounted brake linings and of already replaced brake linings can be stored in the storage device 16. The data which represents a wear state can be read out of the storage device 16 using an external electronic accessory device, for example in a workshop.

Wear states which are analyzed by the control/evaluation device 13 are displayed by one or more display devices, depicted as 17A, 17B, 17C on the circuit board 10, preferably in the form of lighting means, for example LEDs. In addition, a voltage supply display 18 is advantageously provided on the circuit board 10.

The reference symbol 19 designates a further display device, specifically for displaying a break in a cable comprising one of the connecting devices 14A-F, i.e. an interruption, between the connecting device 14A-F and the wear sensor devices 15A-F. Furthermore, a linking device 20 is provided, preferably for passing on the evaluated signal or signals of the wear sensor devices 15A-F to external systems, for example an electric or electronic brake system (brake by wire).

The wear display device according to the present invention can be embodied independently of the standard vehicle electronics and includes a display for the lining wear per brakable wheel or per brakable axle of a corresponding vehicle. Furthermore, in addition to the final wear state it is also possible to display an intermediate wear stage which can be embodied, for example, as a yellow monitoring light next to a red LED for the final wear state. In this embodiment, in addition to the pure final wear state, the driver is provided with an additional signal which ensures that he has a predetermined running capacity, as a predefined value, before the brake linings have to be changed.

Brake lining wear data stored in the storage device 16 may be read out by an external electronic system by means of a code word. For example, both the final wear state, if it is reached, and the intermediate wear stage can be stored in the storage device 16 and read out by an external electronic system by means of a code word, for example at a car dealer service area or a car repair business. This data is used for safety-related maintenance monitoring of the brake linings of the brake system. Furthermore, it is possible to determine the service life of a brake lining precisely if an odometer reading is fed to the control/evaluation device, for example via the linking device 20, and is additionally stored in the storage device 16 simultaneously with the current brake lining wear state.

The wear display device according to the invention provides at least one of the following display possibilities. A display 17A for the final wear state of a brake lining for the entire vehicle; a display 17B for the final wear state of the brake lining per vehicle axle; and/or in each case a display device 17C for the final wear state of the brake lining of each brakable wheel. Moreover, the wear display device according to the present invention preferably also has a display which has a wear prewarning stage of the brake linings in addition to the display of the final wear state according to the above alternatives. Furthermore, a power supply display 18 and a display 19 for a break in the cable of the connecting devices 14A-F, i.e. of the cable harness per wheel, may be provided. If an interruption is present in a connecting device 14A-F to a wear sensor device 15A-F, for example an LED 19 which corresponds to this then lights up. An additional display device 21 preferably indicates whether a parking brake of the vehicle is applied. The electronic evaluation system 13 evaluates a signal of the wear sensor devices 15A-F even if the parking brake is activated.

The present invention provides a wear display device with which the current brake lining wear states can be displayed. The current brake lining wear states can be stored and previously sensed brake lining wear states can be stored, that is to say wear states which have related to already changed brake linings can also be stored.

According to a further embodiment of the present invention there is provision that at the same time as the respective brake lining wear states are stored, the associated odometer reading is retrieved electronically and also stored, as a result of which it is possible to assign the wear state to the odometer reading of the respective vehicle. For this purpose, the storage device is designed for simultaneous storage of the respective odometer reading. The data can be correspondingly retrieved from the memory.

Although the present invention has been described above with respect to a preferred exemplary embodiment, it is not restricted to it but rather can be modified in a variety of ways. For example, in particular, display possibilities other than the proposed lighting means in the form of light emitting diodes, for example an LCD or TFT display, are possible. Furthermore, no specific wear sensor devices have been intentionally specified since sensors which are based on a disconnection of the circuit as well as on magnetic, optical, capacitive features or on ultrasonic features are conceivable. Although the device according to the invention is intended for use in contemporary disk brakes, it is also possible to use it in drum brakes.

I claim:

1. An apparatus for displaying the state of wear of a brake lining on a vehicle, the brake lining wear display apparatus comprising:
a wear sensor for sensing the state of wear of the brake lining;
a display for providing a visual signal indicating the brake lining wear state;
an electronic control/evaluation system for controlling the display device;
an electrical connecting device for connecting the wear sensor to the electronic control/evaluation system, wherein the electronic control/evaluation system evaluates signals from the wear sensor and provides a signal to the display for generating the visual signal;
a memory storage device for storing a current wear state of the brake lining as well as previously sensed wear states; and
a power supply device for providing power to the wear display device.

2. A brake lining wear display apparatus as recited in claim 1, wherein the power supply device comprises an external power supply.

3. A brake lining wear display apparatus as recited in claim 1, wherein the power supply device comprises a battery.

4. A brake lining wear display apparatus as recited in claim 1, wherein the electronic control/evaluation system signals the display device to provide a plurality of visual signals, the visual signals comprising a first visual signal when the wear sensor senses an intermediate stage of brake lining wear and a second visual signal when the wear sensor senses a stage of brake lining wear beyond the intermediate stage.

5. A brake lining wear display apparatus as recited in claim 1, further comprising a display for providing a visual signal indicating status of the power supply.

6. A brake lining wear display apparatus as recited in claim 1, further comprising a display for indicating an interruption in a connecting device between the electronic control/evaluation system and the wear sensor.

7. A brake lining wear display apparatus as recited in claim 1, further comprising a data connection for transmitting signals between the electronic control/evaluation system and an external electronic system.

8. A brake lining wear display apparatus as recited in claim 1, wherein the storage device outputs data signals to the external electronic system via the electronic control/evaluation system only after a predetermined code word has been entered.

9. A brake lining wear display apparatus as recited in claim 1, wherein the display comprises a signal light.

10. A brake lining wear display apparatus as recited in claim 1, wherein the signal light comprises an LED.

11. A brake lining wear display apparatus as recited in claim 1, wherein the electronic control/evaluation system and the display device are arranged on a circuit board.

12. A vehicle, comprising:
a brakable axle including wheels;
a brake lining operatively associated with at least one of the wheels; and
an apparatus for displaying the state of wear of the at least one brake lining, the brake lining wear display apparatus comprising
a wear sensor for sensing the state of wear of the at least one brake lining,
a display for providing a visual signal indicating the brake lining wear state,
an electronic control/evaluation system for controlling the display device,
an electrical connecting device for connecting the wear sensor to the electronic control/evaluation system, wherein the electronic control/evaluation system evaluates signals from the wear sensor and provides a signal to the display for generating the visual signal,
a memory storage device for storing a current wear state of the brake lining as well as previously sensed wear states, and
a power supply device for providing power to the wear display device.

13. A vehicle as recited in claim 12, wherein a brake lining is operatively associated with each of the wheels on the brakable axle, and the brake lining wear display apparatus is provided for each wheel.

14. A vehicle as recited in claim 12, wherein the power supply device comprises a power supply associated with the vehicle.

15. A vehicle as recited in claim 12, wherein the power supply device comprises a battery associated with the brake lining wear display apparatus.

16. A vehicle as recited in claim 12, wherein the electronic control/evaluation system signals the display device to provide a plurality of visual signals, the visual signals comprising a first visual signal when the wear sensor senses an intermediate stage of brake lining wear and a second visual signal when the wear sensor senses a stage of brake lining wear beyond the intermediate stage.

17. A vehicle as recited in claim 12, wherein the brake lining wear display apparatus further comprises a display for indicating an interruption in a connecting device between the electronic control/evaluation system and the wear sensor.

18. The vehicle as recited in claim 12, wherein the display is disposed in the chassis or in the passenger compartment of the vehicle.

19. A vehicle as recited in claim 12, wherein the brake lining wear display apparatus further comprises a data connection for transmitting signals between the electronic control/evaluation system and an external electronic system.

20. A vehicle as recited in claim 19, wherein the external electronic system comprises an electric brake system associated with the vehicle.

21. A vehicle as recited in claim 19, wherein the external electronic system comprises an odometer, and wherein the current odometer reading is simultaneously stored in the memory storage device with the current wear state of the brake lining.

22. A vehicle as recited in claim 19, further comprising a parking brake, and wherein the external electronic system comprises means for sensing the status of the parking brake for signaling sending a signal to the electronic control/evaluation system when the parking brake is activated.
